(19) United States
(12) Patent Application Publication
(10) Pub. No.: US 2011/0021168 A1
(43) Pub. Date: Jan. 27, 2011

(54) METHOD AND APPARATUS FOR RECEIVER WITH DUAL MODE AUTOMATIC GAIN CONTROL (AGC)

(75) Inventors: Haim M. Weissman, Haifa (IL); Zoran Janosevic, Farnborough (GB); Avigdor Brillant, Haifa (IL)

Correspondence Address: QUALCOMM INCORPORATED, 5775 MOREHOUSE DR., SAN DIEGO, CA, 92121, US

(73) Assignee: QUAL COMM Incorporated, San Diego, CA (US)

(21) Appl. No.: 12/508,300

(22) Filed: Jul. 23, 2009

(51) Int. Cl. H04B 1/06

(52) U.S. Cl. 455/234.1

(57) ABSTRACT

A method and apparatus for toggling between a first mode and a second mode of a receiver based on an input signal level comprising comparing a gain state of the receiver to at least one gain state thresholds; determining the presence of a jammer; and switching a current mode of the receiver to a new mode based on the presence of the jammer and the comparison of the gain state. In one aspect, the apparatus comprises two LNAs operating in different modes; a jammer detector to provide a jammer interrupt bit to indicate the presence of a jammer; and an automatic gain control (AGC) circuit coupled to the jammer detector for receiving the jammer interrupt bit, wherein the AGC circuit selects between the two LNAs based on the jammer interrupt bit and a gain state comparison.

### FIELD

The present disclosure relates generally to apparatus and methods for communication receivers. More particularly, the present disclosure relates to a dual mode AGC receiver with automatic gain control.

### BACKGROUND

In a conventional communications receiver, there are two conflicting requirements: high sensitivity and high linearity. High sensitivity refers to the receiver characteristic of a low noise figure with high gain so that the receiver is sensitive to a weak signal. A low noise figure LNA provides better sensitivity to the receiver and good SNR for a weak signal. However, a low noise figure LNA with high gain fails to provide adequate SNR in the presence of strong interference (i.e., jammer) because the intermodulation level increases. The intermodulation level increase is due to the low third order intercept point (IP3) and low 1 dB compression point (P1 dB) for a high sensitivity receiver. Other effect is low second order intercept point (IP2) which appears and affects the IF noise in superheterodyne receivers as well as in ZIF (zero IF) and VLF (very low IF) receivers. An example for such phenomena cause can be a mixer.

High linearity refers to the receiver characteristic of a high third order intercept point (IP3) and a high 1 dB compression point (P1 dB). A high linearity receiver has improved immunity against strong signals and against strong interferences (i.e., jammers). That is, a high linearity receiver has less distortion (e.g., intermodulation product levels, gain compression, phase non-linearity, AM-PM conversions, etc.) in the presence of strong signals or strong interferences than a high sensitivity receiver. However, a high linearity receiver (i.e., its LNA) has a higher noise figure and lower gain and therefore cannot provide optimal sensitivity and SNR in the presence of a weak jammer or if no jammer appears at all.

There is a system design tradeoff between optimizing the receiver design for weak signals versus for strong signals. Thus, high sensitivity receivers are optimal for weak signals and high linearity receivers are optimal for strong signals.

However, in many cases there are combinations of weak desired signals and strong undesired jammers present in the receiver input. In one example, a weak desired signal and a strong undesired jammer are being received simultaneously. In this case, a high sensitivity receiver may have degraded signal-to-noise ratio (SNR) performance due to gain compression and intermodulation distortion because of the presence of the strong jammer in the receiver input. On the other hand, a high linearity receiver may also have degraded SNR performance due to the higher noise-figure causing higher noise level and the reduced sensitivity to the weak desired signal. Thus, either one of the receiver designs (high sensitivity or high linearity) is subject to a compromise, that is, a choice to balance noise figure, IP3 and P1 dB performance.

### SUMMARY

Disclosed are a method and apparatus for providing a dual mode AGC receiver design which can toggle between a high sensitivity low noise amplifier (LNA) and a high linearity LNA, depending on the input signal environment. In one aspect, the dual mode AGC receiver includes jammer detection.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1A illustrates an example overview of a very wideband dual mode AGC receiver system for multi-radio system management.

FIG. 1B illustrates a carrier to noise (C/N) characteristic with no jammer present compared to a carrier to noise plus third order intermodulation level (C/(N+IM)) characteristic with a jammer present for a conventional receiver.

FIG. 2 illustrates an example for optimizing the SNR (e.g., C/N) by combining a high linearity characteristic and a high sensitivity characteristic in a receiver.

FIG. 3 illustrates an example of a dual mode AGC receiver front-end.

FIG. 4 illustrates an example of a state transition diagram for the dual modes in terms of switch points (SP) and gain states.

FIG. 5A illustrates an example of the resulting dual mode AGC receiver gain states as a function of input RF level for both the high sensitivity mode (mode 1) and the high linearity mode (mode 2).

FIG. 5B illustrates an example of the resulting dual mode AGC receiver noise figure states as a function of input RF level for both the high sensitivity mode (mode 1) and the high linearity mode (mode 2).

FIG. 6 illustrates an example of operation modes and states diagram.

FIG. 7 illustrates an example of the voltage requirements at the ADC input for different gain states for a receiver with AGC which can be dual mode or not.

FIG. 8 illustrates an example of the carrier to noise ratio (C/N) with increased intermodulation product level for different gain states.

FIG. 9 illustrates an example of a dual mode AGC receiver.

FIGS. 9a, 9b and 9c illustrate three other examples of a dual mode AGC receiver.

FIG. 10A illustrates an example of a block diagram of a jammer detector (JD) coupled to an automatic gain control (AGC) circuit.

FIG. 10B illustrates an example of a very wideband dual AGC receiver block diagram.

FIG. 11 illustrates an example ratio between the RF noise to the ADC noise at the analog output of the mixer/low pass filter (LPF) versus frequency.

FIG. 12 illustrates an example flow diagram for toggling between dual modes based on the input signal environment.

FIG. 13 illustrates an example of a device 1300 suitable for toggling between dual modes based on the input signal environment.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

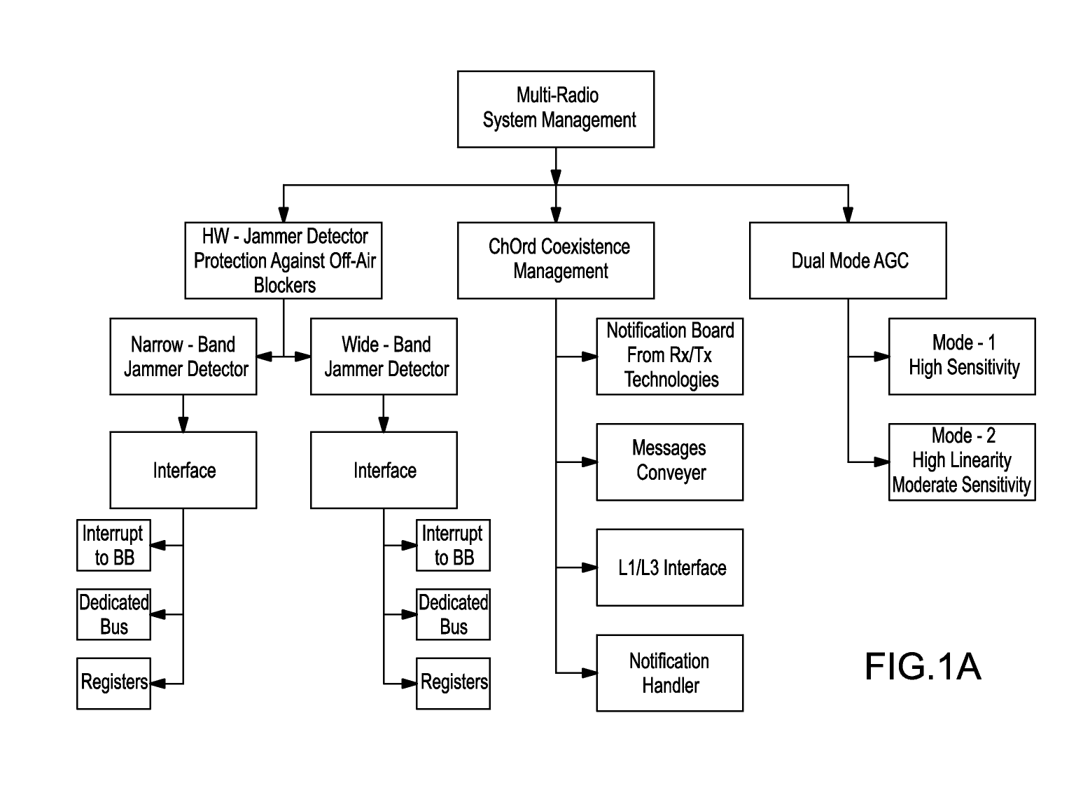

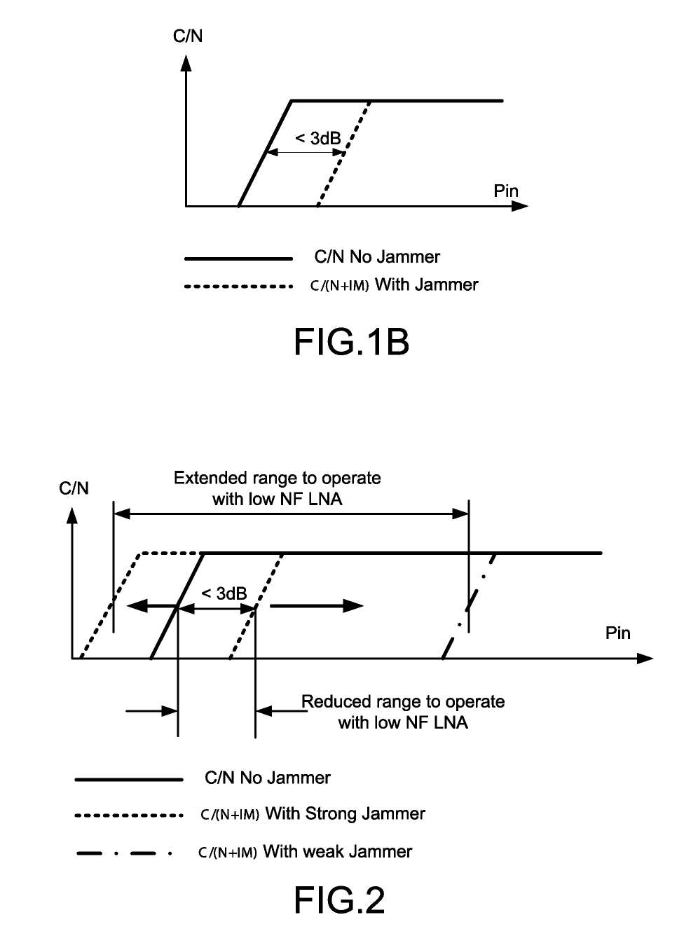

FIG. 1A illustrates an example overview of a very wideband dual mode AGC receiver system for multi-radio system management. The system comprises, for example, a hardware jammer detector for detecting close in and far off jammers, a coexistence management subsystem, and a dual mode AGC receiver. The dual mode AGC receiver consists of a first mode to provide high sensitivity and a second mode to provide high linearity. For the case of low jammers the receiver operates in the first mode to provide high sensitivity but low linearity. In the case of high jammers above a threshold, the AGC receiver switches to the second mode to provide high linearity but moderate sensitivity.

FIG. 1B illustrates a carrier to noise (C/N) characteristic with no jammer present in the receiver input compared to a carrier to noise plus intermodulation level (C/(N+IM)) characteristic with a jammer present for a conventional receiver. This conventional receiver design is based on a compromise between having a high linearity characteristic and a high sensitivity characteristic. Ideally, the conventional receiver of FIG. 1B should operate and receive a weak signal with minimum degradation in presence of a jammer. To optimize the performance of the conventional receiver, one technique is to make the two extremes of the curves less than some value, for example, 3 dB as shown in FIG. 1B. However, this optimization process is a balance between noise figure (NF) and input third order intercept point (IIP3), which defines the intermodulation products and P1 dB which also affects the level of IP3 or higher order IP as an example. The optimization process results in a high linearity receiver. The penalty in using a high linearity receiver is degraded NF (i.e., higher noise figure value) and degraded LNA gain in favor of a higher input third order intercept point (IIP3). And, sensitivity is sacrificed due to reduced SNR by trying to “balance” the conventional receiver.

Using a high sensitivity receiver (i.e., a high sensitivity LNA) over a large dynamic range with weak jammers or no jammers results in improved sensitivity compared to using a high linearity receiver. However, in the presence of a strong jammer, SNR (e.g., C/N) is degraded due to gain compression and intermodulation distortion.

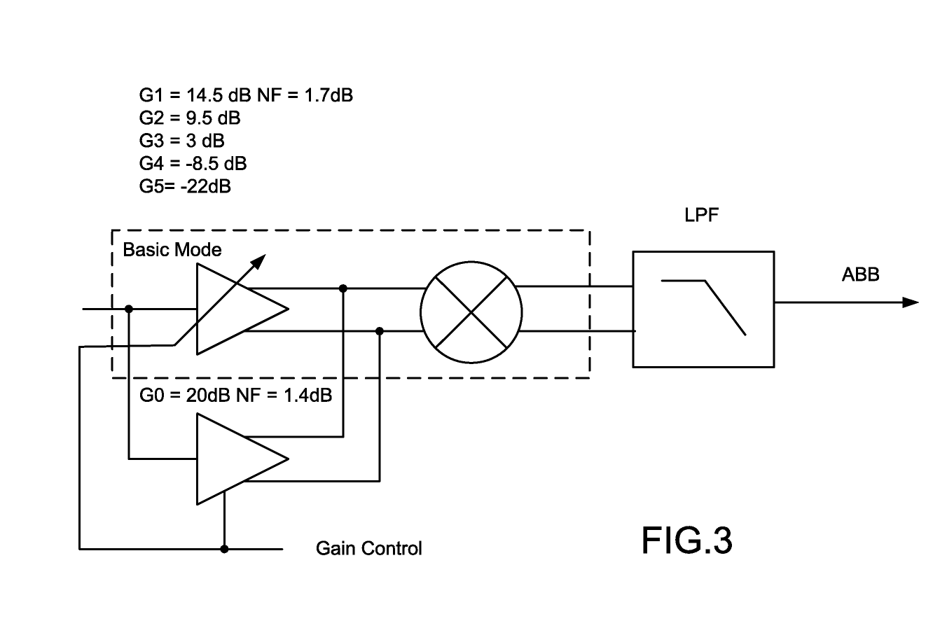

FIG. 2 illustrates an example for optimizing the SNR (e.g., C/N) in a jammer environment by combining a high linearity characteristic and a high sensitivity characteristic in a single dual mode AGC receiver. By combining the two characteristics of high linearity and high sensitivity for different input signal environment in a single dual mode AGC receiver, optimization of the SNR (e.g., C/N) is achieved as shown in FIG. 2. For example, in the presence of weak jammers or no jammers, the dual mode AGC receiver operates with its high sensitivity LNA characteristic, even with high input desired signal levels. On the other hand, in the presence of strong jammers, the dual mode AGC receiver operates with its high linearity LNA characteristic to optimize the SNR (e.g., C/N which is replaced by C/(N+I)).

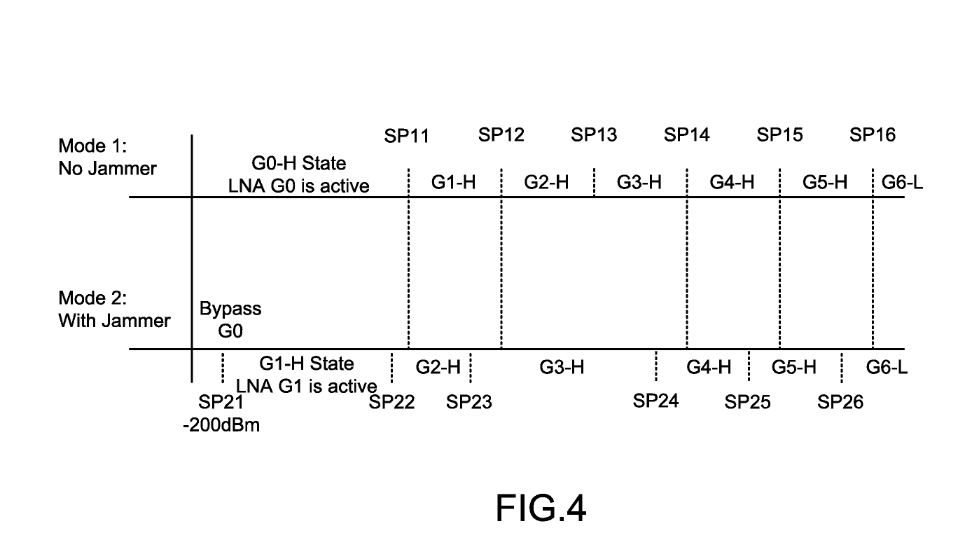

FIG. 3 illustrates an example of a dual mode AGC receiver front-end. In one example, an automatic gain control (AGC) signal from an AGC circuit (not shown) is applied in the dual mode AGC receiver front-end shown in FIG. 3. The AGC circuit increases the dynamic range of the dual mode AGC receiver and limits the receiver output power at a level no greater than the maximum allowed at the analog to digital converter (ADC) input. The AGC operates as a power or voltage limiter at the dual mode AGC receiver output which limits the desired signal level at the ADC input. In one aspect, margins for component tolerances and for unwanted signals power leakage are included in the AGC circuit. In a jammer-free environment, the AGC circuit is optimized such that the receiver meets linearity and sensitivity requirements.

In one example, a jammer detector is included in the dual mode AGC receiver to identify undesired signals and to trigger a switch between the dual modes—the high linearity mode and the high sensitivity mode. For example, the dual modes are: 1) high sensitivity mode for low power signals and weak or no jammers and 2) high linearity mode with moderate sensitivity for strong jammers (shown within the dash lines). FIG. 3 shows some example gain state values for the dual modes. For example, the high sensitivity mode includes gain state G0 at 20 dB with a noise figure of 1.4 dB. The high linearity mode includes five gain states, for example, G1 at 14.5 dB (with noise figure at 1.7 dB), G2 at 9.5 dB, G3 at 3 dB, G4 at −8.5 dB and G5 at −22 dB. In one aspect, the dual mode AGC receiver (i.e., dual mode LNA) is implemented as a parallel path. In another aspect, the dual mode AGC receiver (i.e., dual mode LNA) is implemented as a single path.

In one example, two AGC tables are included in a processor within the dual mode AGC receiver. One AGC table is used for the high sensitivity mode where the low noise figure LNA is used. The second AGC table is used for the high linearity mode where the high IP3 LNA is used. The two AGC tables allow for maximizing the use of the high sensitivity LNA to improve system sensitivity at wider signal range and to switch to the high linearity LNA based on the response of the jammer detector when a detected jammer crosses a predefined threshold. In one aspect, the values in the AGC tables are based on one or more of the following: gain compression point; mixer protection; ADC protection against saturation; and intermodulation product level per CNR degradation. Another example can be several tables for mode 1 with optimized switch points and settings vs. frequency of operation and a table for mode 2 with optimized switch points and settings vs. frequency of operation. Another example is an adaptive switch point table which is based on, for example, frequency, the modulation scheme or a combination of all parameters.

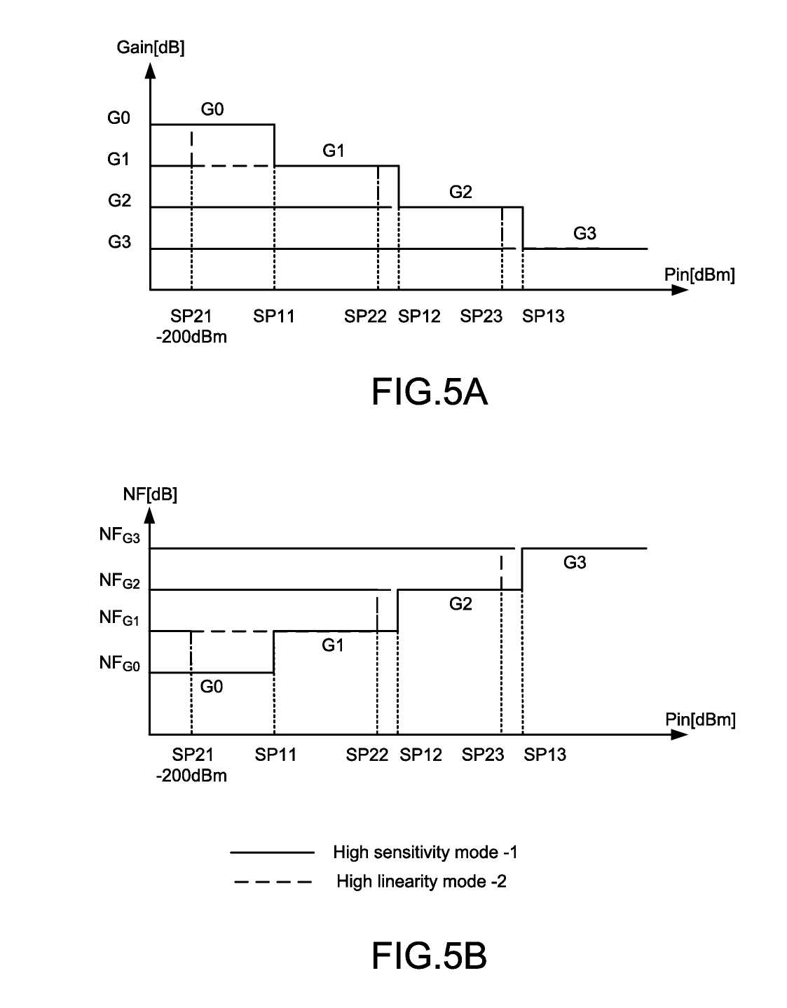

FIG. 4 illustrates an example of a state transition diagram for the dual modes in terms of switch points (SP) and gain states. Switch points are denoted as SPxy with the x value denoting the mode and the y value denoting the switch point. In FIG. 4, each mode (mode 1 and mode 2) has six switch points. Gain states are denoted as G0 through G6 for mode 1 and G1 through G6 for mode 2. G0 is bypassed in mode 2. The top line shows the state transitions for the high sensitivity mode (mode 1) and the bottom line shows the state transitions for the high linearity mode (mode 2). As shown in FIG. 4, at each switch point, a different gain state is selected.

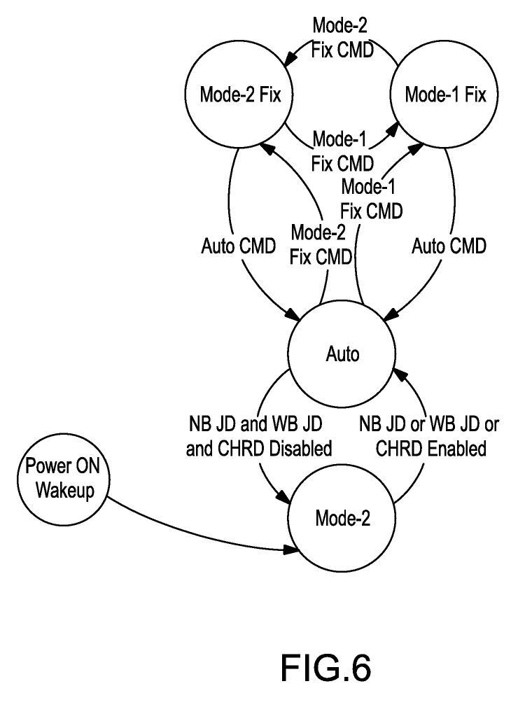

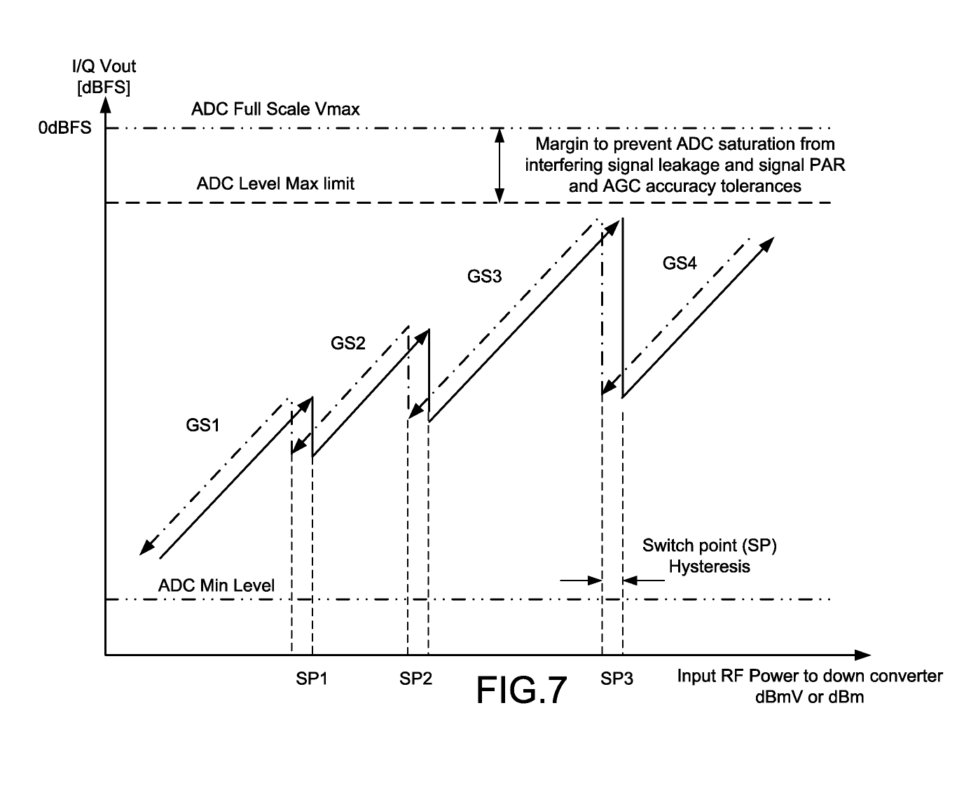

FIG. 5A illustrates an example of the resulting dual mode AGC receiver gain states as a function of input RF level for both the high sensitivity mode (mode 1) and the high linearity mode (mode 2). As shown in FIG. 5A, in mode 1, the dual mode AGC receiver starts at the highest gain state G0 for low input power levels (Pin) and transitions to successive gain states (G1, G2, G3, . . . ) at corresponding switch points (SP11, SP12, SP13 . . . ) as the input power level (Pin) increases. As shown in FIG. 5A, in mode 2, the dual mode AGC receiver starts at the gain state G1 for low input power levels (Pin) and transitions to successive gain states (G2, G3, . . . ) at corresponding switch points (SP22, SP23 . . . ) as the input power level (Pin) increases. Switch point SP21 for mode 2 is set at a very low input power level, for example −200 dBm, to bypass gain state G0 in mode 2.

FIG. 5B illustrates an example of the resulting dual mode AGC receiver noise figure states as a function of input RF level for both the high sensitivity mode (mode 1) and the high linearity mode (mode 2). As shown in FIG. 5B, in mode 1, the dual mode AGC receiver starts at the highest gain state G0 and the lowest noise figure NF_{G0} for low input power levels (Pin) and transitions to successive gain states (G1, G2, G3, . . . ) with corresponding noise figures (NF_{G1}, NF_{G2}, NF_{G3} . . . ) at corresponding switch points (SP11, SP12, SP13 . . . ) as the input power level (Pin) increases. As shown in FIG. 5B, in mode 2, the dual mode AGC receiver starts at the gain state G1 and corresponding noise figure NF_{G1} for low input power levels (Pin) and transitions to successive gain states (G2, G3, . . . ) with corresponding noise figures (NF_{G2}, NF_{G3} . . . ) at corresponding switch points (SP22, SP23 . . . ) as the input power level (Pin) increases. Switch point SP21 for mode 2 is set at a very low input power level, for example −200 dBm, to bypass gain state G0 in mode 2.

Based upon the state of the jammer detector, the AGC switch points are advanced or retarded, with respect to each other as illustrated in FIG. 4. The AGC switch points affect the LNA gain states and noise figure versus the RF input power as shown in FIG. 5A. At high gain states, the AGC switch points can be merged or not merged. The merging characteristic depends on the output voltage level versus input power, where the output voltage level is limited to not exceed the ADC full scale reference to prevent ADC saturation. In one aspect, the values of the switch points are modified to switch earlier in the presence of a jammer. In one aspect, the values of the switch points between gain states (other than the G0 state) are adaptive based upon the jammer level.

In one aspect, the switch points (SP) defined above are updated when switching between modes. Additionally, the switching logic includes hysteresis to prevent toggling between modes. In another example, each jammer detector (JD) has its own switch point register to store its thresholds. In another aspect, for higher gain states, for example gain states above G3, the JD may optionally be ignored. In another example, at high gain states, the AGC SPs merge to be the same.

In another aspect, the AGC switch point table may be adaptive based on the received jammer level. The AGC switch point table is based on several parameters such as the receiver compression point, the ADC saturation point, the IMR3 level which degrades the carrier/noise ratio and frequency of operation which affects the mentioned parameters as well as gain response. In a jammer-free environment, the AGC switch points are optimized for the receiver to meet linearity and sensitivity requirements. In one example, the AGC switch points may be modified to transition earlier based on the presence of a jammer. The modification may be adaptive based on the received jammer power level.

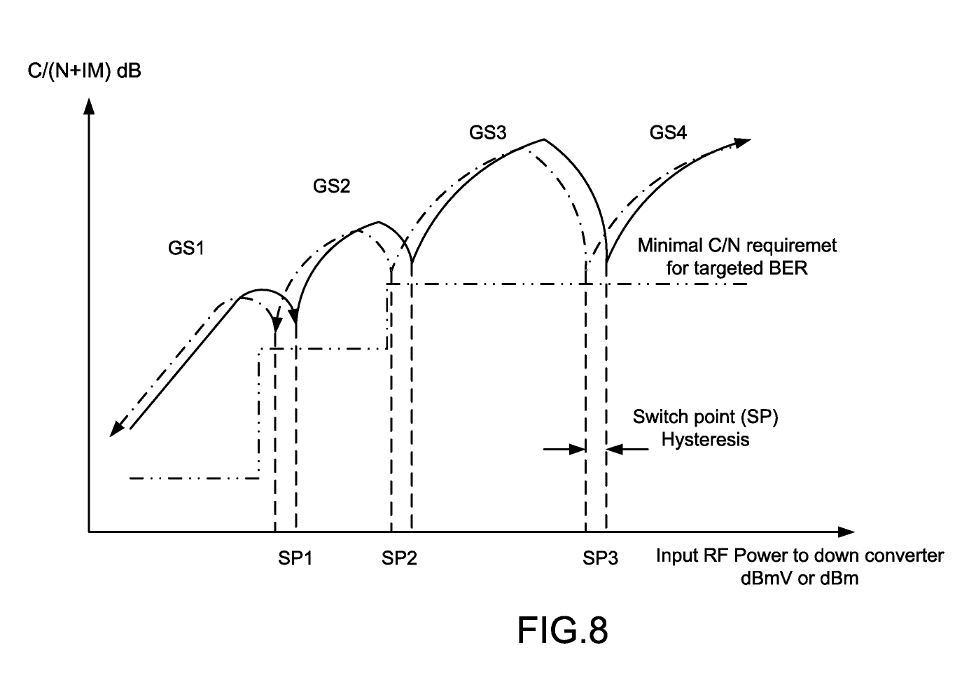

FIG. 6 illustrates an example of operation modes and states diagram. FIG. 6 shows the transitions among the various operational states include Mode 1 for the high sensitivity receiver state and Mode 2 for the high linearity receiver state as well as debug modes and fixed modes.

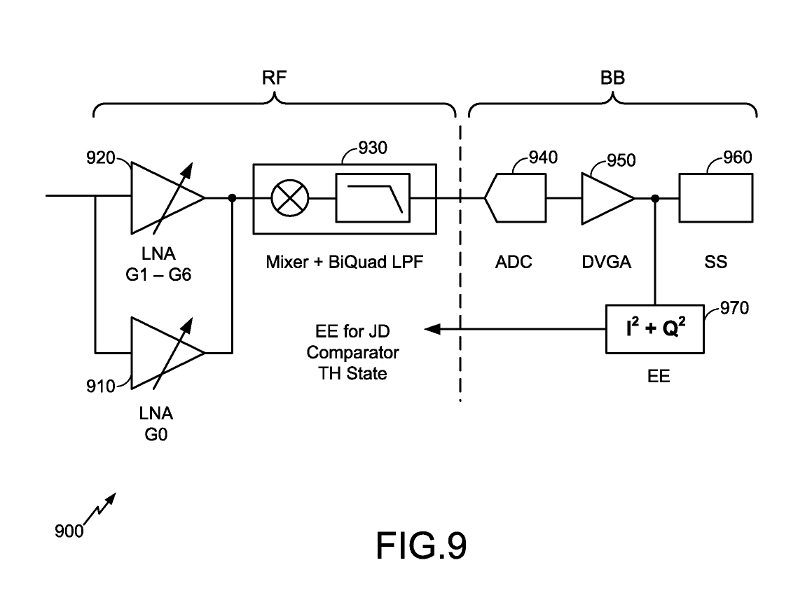

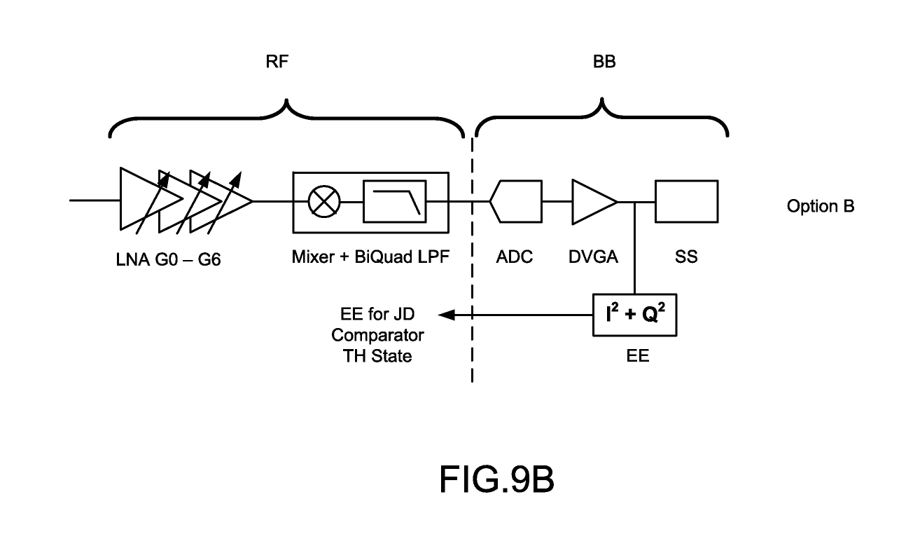

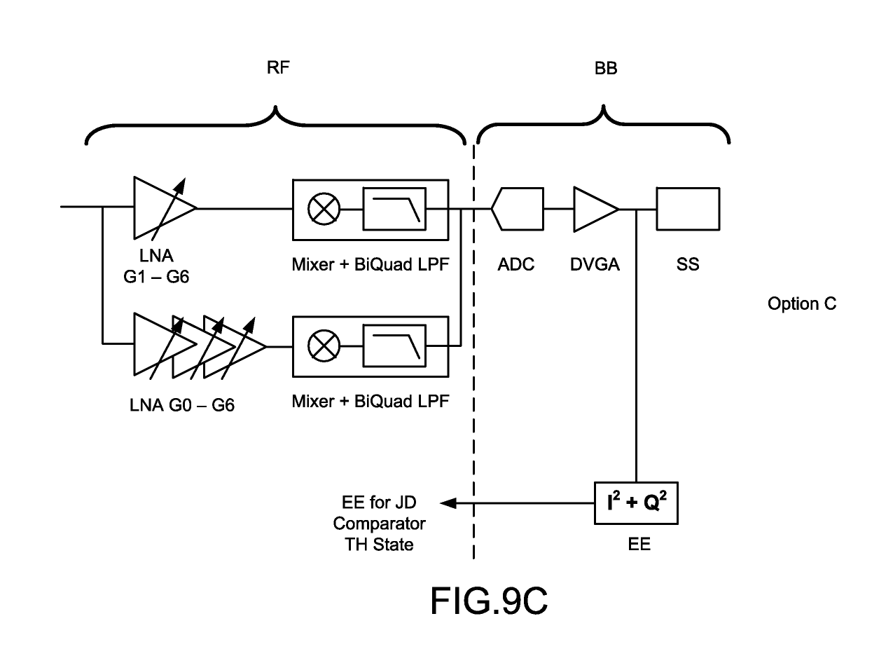

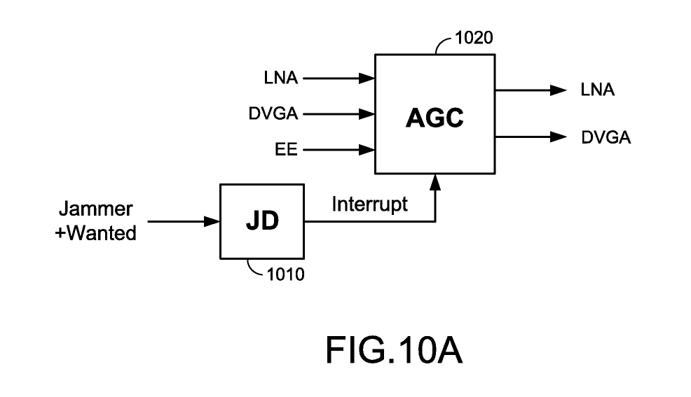

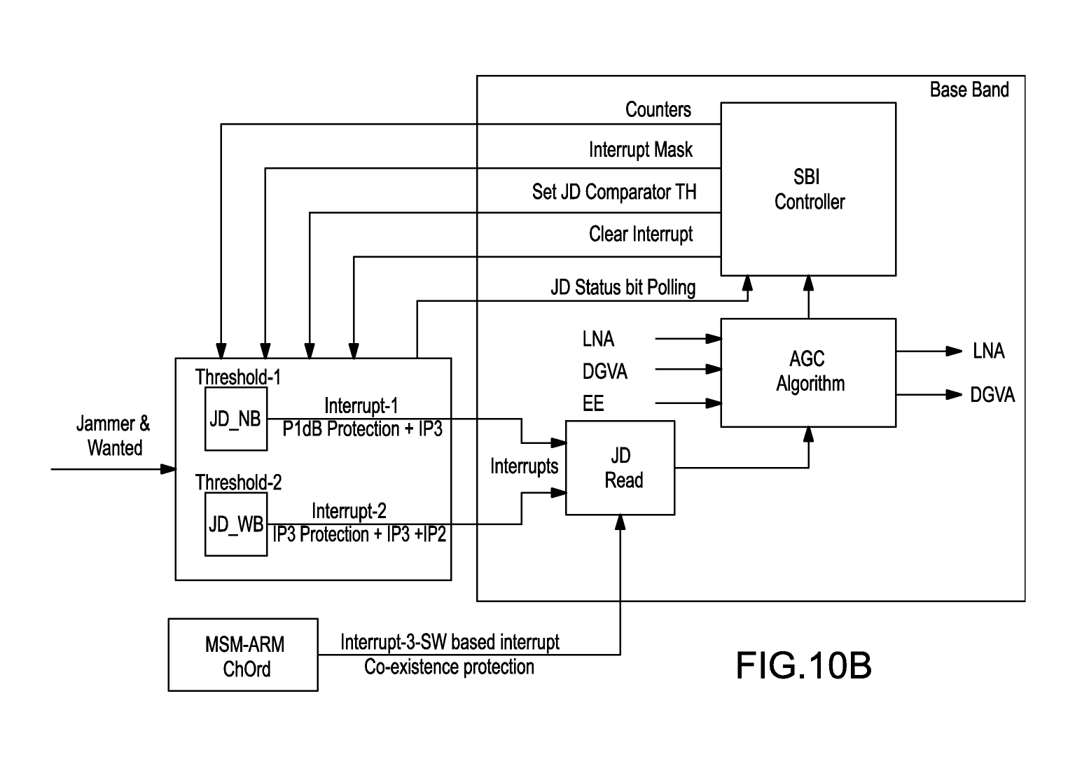

FIG. 7 illustrates an example of the voltage requirements at the ADC input for different gain states for a receiver with AGC which can be dual mode or not. FIG. 7 is a graph of the output voltage from the RF section of the dual mode AGC receiver shown in FIG. 9 (i.e., the input voltage to the ADC) as a function of the input RF power to the mixer shown in FIG. 9. As the input RF power increases, the AGC circuit shown in FIG. 10A sets the gain state (denoted as GS1, GS2, GS3, GS4 . . . which are also denoted as G1, G2, G3, G4 . . . ) such that the output voltage from the RF section (i.e., the input voltage to the ADC) is maintained below the ADC level max limit. The ADC level max limit is a margin against the ADC full scale maximum voltage as shown in FIG. 7. The margin prevents ADC saturation from interfering signal leakage and signal peak to average ratio (PAR), and to accommodate AGC accuracy tolerances.

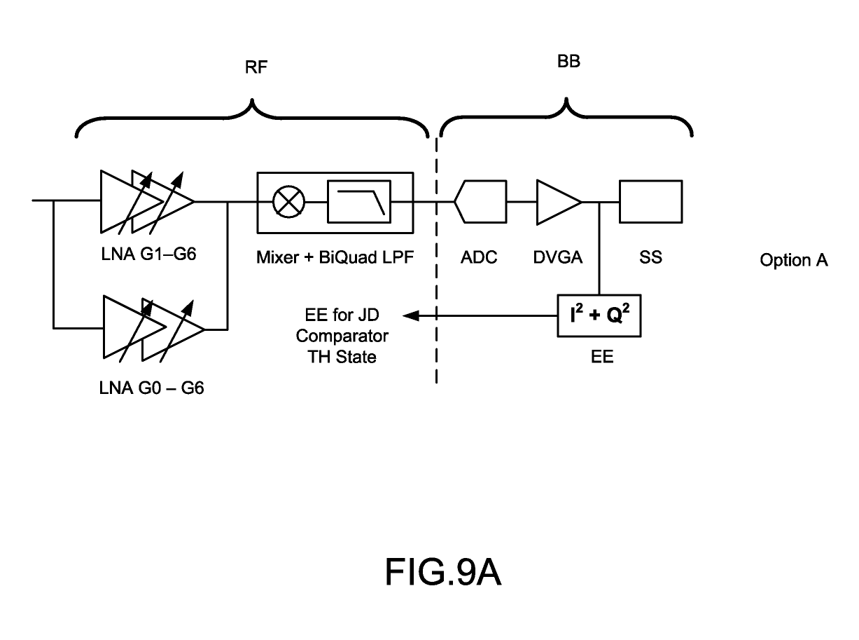

FIG. 8 illustrates an example of the carrier to noise ratio (C/N) with increased intermodulation product level for different gain states versus input RF power level to the mixer shown in FIG. 9. As shown in FIG. 8, the carrier to noise ratio (C/N) is degraded due to the increased intermodulation product level as the input level increases. In one example, such an increase occurs due to the presence of a strong jammer. Hysteresis between increasing power and decreasing power is introduced to the AGC circuit to prevent toggling at the switch points. In the high sensitivity mode (mode 1), the RF chain has higher gain and lower noise figure, which increases the dual mode AGC receiver sensitivity. On the other hand, at the high linearity mode (mode 2), the dual mode AGC receiver is operating at lower gain and higher noise figure. In one example, the nominal gain (G0) state in the high linearity mode is bypassed by setting the first mode 2 switch point (SP21) to −200 dBm (as shown in FIG. 4) to protect the dual mode AGC receiver against C/N degradation due to the presence of strong jammers.

A dual mode AGC receiver toggles between two modes. In one aspect, the two modes include a high sensitivity mode (mode 1) and a high linearity mode (mode 2), and the dual mode AGC receiver toggles between these two modes depending on the input signal environment. If the dual mode AGC receiver is in high sensitivity mode, it may need immediate protection when a strong jammer appears. In one example, such protection is implemented using a fast attack automatic gain control (AGC) circuit or algorithm or both. Fast attack refers to a property of the AGC circuit or algorithm or both which is a rapid gain reduction after the appearance of a strong input signal level (e.g., jammer). Then, when the strong jammer disappears, the dual mode AGC receiver may require a slow release AGC circuit to avoid fast toggling between the two modes. Slow release refers to a property of the AGC circuit or algorithm or both which is a slow gain increase after the disappearance of a strong input signal level (i.e., the strong jammer). Fast attack slow release or slow decay JD is a borrowed terminology from AGC which describes rapid gain decrement when receiving a strong signal and slow convergence to the final gain value. In this invention there are two systems. AGC and Jammer detector. The jammer detector operates in fast attack slow release mode due to the following reasons. The first priority is to protect the receiver and maintain quality of service. Hence, the jammer detector operates in fast attack mode and transfers the receiver into protected mode. This mode is defined as “mode 2” which is high linearity moderate sensitivity. Secondly, it is assumed that receiving environment is varying slowly, (jammers do not appear and disappear quickly). Thus there is a slow release process in order to avoid toggling between the two modes and thereby reduce the receiver's performance. Additionally, the slow release process protects the system against fading and prevents signal distortion. The jammer detector signaling at attack informs BB (e.g., AGC circuit or algorithm or both) to switch from mode 1 AGC table to mode 2 AGC table. Note that the AGC table is the table of gain state switch points vs. input power, and other settings such as current settings etc. The mode 1 switch point table is used for high sensitivity low linearity mode. Hence it includes the G0 gain state. The mode 2 AGC table is used for high linearity moderate sensitivity. Thus it bypasses the G0 gain state by having its switch point set to, for example, −200 dBm intentionally. As a consequence, mode 2 start at the G1 gain state and is the traditional receiver mode in which the design is a tradeoff between sensitivity and linearity. As a result of the jammer detector interrupt, the gain of the system is reduced. The system maintains a low gain and mode 2 switch point AGC table for a predetermined release time. The AGC manages the receiver's gain with mode 2 table of a lower gain and switches back to mode 1 only after release time had shown no jammer during its release period. Thus the slow release refers to AGC and JD operation which means slow gain increase after the jammer has disappeared.

In conventional receiver designs, the AGC circuit is triggered by a single jammer detector (JD) designed for narrowband operation over a single radio frequency (RF) band. However, in many wireless scenarios, there are several interfering transmitters operating at various frequency bands, transmit power levels, and modulation schemes. A single jammer detector is not optimal for detecting a variety of jammers over a very wide bandwidth. Yet, there is a need to protect the receiver against all jammers present in the wideband environment.

In conventional receiver designs there is a single AGC switch point table and the design is a compromise between linearity and sensitivity. Hence the traditional design is similar to the mode 2 design which is the protected mode. There is no sensitivity improvement in case jammers are below a certain pre-determined threshold. Conventional receivers sacrifice sensitivity and protect against jammers by increasing the current at the LNA and mixer. Moreover, conventional receivers do not have a fast attack slow release JD process to operate in burst mode. This invention contains two types of jammer detectors. The receiver includes a narrowband jammer detector that monitors inband close in jammers such as alternate jammers appearing up to N+4 (i.e., the 4th adjacent band) as an example. The narrowband JD is implemented in the analog baseband of the receiver prior the baseband filter to sense the jammers or in IF frequency in a superheterodyne receiver or any other low frequency receiving block in a receiver. Additionally, the receiver has a wideband jammer detector to protect the receiver against inband far off jammers.

FIG. 9 illustrates an example of a dual mode AGC receiver 900. In one example, the dual mode AGC receiver with automatic gain control (AGC) has two modes for the AGC with two switch point tables for the gain states. Moreover the dual mode AGC receiver has two LNA paths, one for high sensitivity low current (mode 1) and the other for high linearity moderate sensitivity (mode 2).

For the dual mode AGC receiver, mode 1 has high sensitivity and low linearity characteristics. Mode 2 has high linearity and moderate sensitivity characteristics. Mode 1 employs an LNA with low noise figure, high gain, and low current consumption. Mode 1 is used when a low level jammer or no jammer is present at the receiver input. Mode 2 employs an LNA with lower gain, higher IP3, and higher current consumption. Mode 2 is used when a strong jammer is present in the dual mode AGC receiver input. The transition between the two modes is implemented by an automatic gain control (AGC) circuit triggered by a jammer detector (JD) which is not shown in FIG. 9. The AGC switches between mode 1 switch point table (high sensitivity, low NF) to mode 2 switch point table (high linearity moderate sensitivity) in case a strong jammer was detected.

In one example, an input RF signal is captured by a receive antenna (not shown) coupled to the dual mode AGC receiver and is sent to the inputs (910, 920 respectively) of both mode 1 LNA and mode 2 LNA for low noise amplification and production of the mode 1 output RF signal and mode 2 output RF signal, respectively. Mode 1 LNA has input 910, and Mode 2 LNA has input 920 as shown in FIG. 9. The AGC circuit provides a mechanism (not shown) to select between the mode 1 output RF signal and the mode 2 output RF signal to yield a selected output RF signal. One skilled in the art would understand that various mechanisms known in the field can be used to select the modes without affecting the spirit and scope of the present disclosure.

The selected output RF signal is sent to the mixer/low pass filter (LPF) 930 for frequency downconversion and production of the input baseband signal. The input baseband signal is sent to the analog-to-digital converter (ADC) 940 for conversion to an input digital signal. The input digital signal is then sent as an example to a digital variable gain amplifier (DVGA) 950 for gain adjustment and production of the output digital signal. The output digital signal is then sent to the as an example sample server (SS) module 960 for capturing the digital symbols and transfer them for further demodulation process and also to the energy estimator (EE) 970 for estimation of the energy of the output digital signal (e.g., receiver output energy).

In one aspect, the dual mode AGC receiver toggles between a first mode and a second mode based on an input RF signal level. As shown in FIG. 9, the dual mode AGC receiver comprises a first LNA operating in the first mode, a second LNA operating in the second mode, a jammer detector to provide a jammer interrupt bit to indicate the presence of a jammer, and an automatic gain control (AGC) circuit or algorithm or both coupled to the jammer detector for receiving the jammer interrupt bit, wherein the AGC circuit selects between the first LNA and the second LNA based on the jammer interrupt bit and a gain state comparison. The dual mode AGC receiver further includes a mixer coupled to one of the two LNAs and downconverts the input RF signal to a downconverted signal. The dual mode AGC receiver includes a low pass filter (LPF) coupled to the mixer for filtering the downconverted signal to generate a filtered downconverted signal. The filtered downconverted signal is inputted to an analog to digital converter (ADC) which digitizing the filtered downconverted signal to produce a digitized signal. The digitized signal is then inputted into a digital variable gain amplifier (DVGA), wherein the DVGA scales the digitized signal. An energy estimator coupled to the DVGA receives the scaled digitized signal and uses it to estimate a receiver output energy. The receiver output energy is then inputted to the jammer detector and use in setting a jammer detector threshold. The value of the jammer interrupt bit which indicates the presence of a jammer is based on a comparison of the level of the RF input signal against the jammer detector threshold. In one aspect, the dual mode AGC receiver comprises a processor to obtain a normalized receiver input energy at the input to one of the two LNAs based on the receiver input energy at baseband. As shown in FIG. 9, the receiver input energy at baseband can be tapped at any of the outputs of the ADC or the DVGA, or at the input to the ADC. The processor sets a new gain of the dual mode AGC receiver to reflect the new mode and the normalized receiver input energy wherein the processor directs the jammer detector to update the jammer detector threshold. In one example, the processor is part of the AGC circuit.

FIGS. 9a, 9b and 9c illustrate three examples of a dual mode AGC receiver. FIG. 9a shows one example of the dual mode AGC receiver with two LNA paths, each path using a full gain chain. The mode 2 LNA includes six gain states G1 to G6 with all six gain states operating at high current. The mode 1 LNA includes seven gain states G0 to G6 with all seven gain states operating at low current. FIG. 9b shows a second example of the dual mode AGC receiver with a single LNA path containing gain states G0 to G6. In the example in FIG. 9b, gain state G0 is part of the gain chain, but G0 is skipped when the dual mode AGC receiver is operating at mode 2. FIG. 9c shows a third example of the dual mode AGC receiver with two LNA paths, each using a full gain chain and a dedicated mixer/low pass filter. The mode 2 LNA includes six gain states G1 to G6 with all six gain states and the mixer/low pass filter operating at high current. The mode 1 LNA includes seven gain states G0 to G6 with all seven gain states and the mixer/low pass filter operating at low current. One skilled in the art would understand that in one aspect, high current and low current are meant to imply relative values to each other.

FIG. 10A illustrates an example of a block diagram of a jammer detector (JD) 1010 coupled to an automatic gain control (AGC) circuit 1020. The jammer detector (JD) 1010 and the automatic gain control (AGC) circuit 1020 are coupled to the dual mode AGC receiver 900 shown in FIG. 9. In one aspect, the jammer detector (JD) 1010 and the automatic gain control (AGC) circuit 1020 are part of the dual mode AGC receiver 900. A jammer detector input signal, which contains both the jammer and desired signal, is sent to the jammer detector (JD) 1010 for detection of a strong jammer. In one example, the jammer detector input signal is the output of the energy estimator (EE) 970 (shown in FIG. 9). If the level of the jammer detector input signal exceeds a predetermined jammer detector threshold THⱼ, a jammer detector interrupt bit is set by the jammer detector (JD) 1010 and sent to the AGC circuit 1020. In one example, a jammer detector interrupt bit=1 means a jammer level above THⱼ has been detected. And, a jammer detector interrupt bit=0 means no jammer level above THⱼ has been detected. In one example, the jammer detector threshold THⱼ is applied to a comparator within the jammer detector. In one aspect, the jammer detector 1010 is a combination of a plurality of jammer detectors, each set with a predetermined jammer detector threshold THⱼ value. In one aspect, the jammer detector 1010 is based on several complementary jammer detectors, both hardware and software-based. The jammer detector 1010 incorporates a narrowband jammer detector (NB JD) to detect inband jammers, a wideband jammer detector (WB JD) to detect out of band jammers and far off jammers, and a software jammer detector (SW JD) for concurrent operation jammers. Each of the NB JD, WB JD and SW JD has its own optimized jammer detector threshold (THⱼ). One skilled in the art would understand that in accordance with the spirit and scope of the present disclosure, the jammer detector 1010 may be a plurality of jammer detectors, each set with a predetermined jammer detector threshold THⱼ value.

The AGC circuit 1020 accepts the jammer detector interrupt bit or interrupt status bit, as well as the current LNA gain state, current DVGA gain state, and current EE value, as inputs to the AGC circuit or algorithm or both of them. The outputs of the AGC circuit are an updated LNA gain state and an updated DVGA gain state, based on the various AGC inputs. The AGC circuit selects between one of the two LNAs based on the jammer interrupt bit and a gain state comparison of the current LNA gain state to a series of gain state thresholds. In one example, the outputs of the AGC circuit or algorithm or both of them are directed to one of the two LNAs and the DVGA 950 (shown in FIG. 9). The AGC circuit or algorithm or both of them 1020 incorporates two AGC tables which govern the selection of gain states in the high sensitivity mode (mode 1) and in the high linearity mode (mode 2). In one example, if the dual mode AGC receiver is set to mode 1 (high sensitivity mode) and the jammer detector interrupt bit is asserted HIGH (i.e., bit=1), to indicate the presence of a strong jammer, the AGC circuit 1020 responds by setting the updated LNA gain state and updated DVGA gain state to their appropriate values in mode 2 (high linearity mode). In one aspect, the two AGC tables are combined as one AGC table. In another example, if the dual mode AGC receiver is set to mode 2 (high linearity mode) and the jammer detector interrupt bit remains LOW (i.e., bit=0) for a predetermined period of time, to indicate the absence of a strong jammer for a predetermined period of time, the AGC circuit 1020 sets the updated LNA gain state and updated DVGA gain state to their appropriate values in mode 1.

FIG. 10B illustrates an example of a very wideband dual AGC receiver block diagram. The jammer detector 1010 of FIG. 10A is shown in more detail in FIG. 10B as comprising of three separate detectors: a narrowband jammer detector, a wideband jammer detector, and a software-based jammer detector. Interrupts from these three detectors are sent to the JD Read block which sends a composite interrupt signal to the AGC algorithm block for control of the gain states as described earlier. In addition, a serial bus interface (SBI) Controller provides several control signals (counters, interrupt mask, threshold set, and interrupt clear) to the jammer detectors based on the status of the JD and AGC algorithm.

In one aspect, the mode 2 (high linearity mode) LNA has a plurality of gain states. In one example, the mode 2 LNA has three gain states, G1, G2, and G3, in order of decreasing gain and increasing noise figure. Additionally, mode 2 may have other higher gain states G4, G5 and G6. In one aspect, in the AGC circuit, the mode 2 LNA gain state depends on the crossing of an AGC switch point. In one example, the mode 1 LNA has a plurality of gain states. One skilled in the art would understand that the quantity of gain states for mode 1 and/or mode 2 can be chosen depending on the particular application and design parameters without affecting the spirit or scope of the present disclosure.

Each of the two AGC tables contains a set of AGC switch points (SPs) corresponding to each of the two modes of the dual mode AGC receiver. In one example, for mode 1, the AGC switch point (SP) for a transition from gain state G0 to G1 is approximately −80 dBm. The gain state G0 corresponds to the low noise figure, high gain LNA path in mode 1. In one example, for mode 2, the AGC switch point (SP) for a transition from gain state G0 to G1 is set very low, for example, to approximately −200 dBm, so that effectively the gain state G0 is skipped and gain state G1 is active at lower input signal level conditions. In one aspect, the settings of the AGC switch points (SPs) are updated when switching between the two modes. Hysteresis is added to prevent toggling between the two modes.

The dual mode AGC receiver improves receiver sensitivity in the presence of jammers compared to conventional single mode receivers. In addition, the dual mode AGC receiver provides buffering against analog to digital converter (ADC) noise such that the overall system noise figure is minimized. For example, in digital receivers the analog signal of the receiver is sampled by an analog to digital converter (ADC). The ADC produces ADC noise denoted as N_{ADC}. The design of the digital receiver is governed by the desired carrier to noise ratio (C/N). The design parameters of the LNA are chosen to optimize the C/N. The effect of the noise figure of the LNA on the total RF noise figure is described by equation (1).

$${F}_{T} = {F}_{1} + \frac{{F}_{2} - 1}{{G}_{1}} + \frac{{F}_{3} - 1}{{G}_{1} {G}_{2}} + … = {F}_{1} + {F}_{eq} \qquad ( 1 )$$

Equation (1) shows that an LNA which has low noise figure F₁ and high gain G₁ compensates for the noise figure of the rest of the RF chain resulting in a lower F_{eq}. By extension, the LNA also compensates for the ADC noise. The RF section at the ADC input has noise figure F_{T} and gain G_{T}. The ADC may be modeled as a cascaded block with noise figure F_{ADC}. Therefore, the ADC noise at its input port is given by equation (2). The ADC noise contains quantization noise, thermal noise and other noise components.

N_{ADC}=kTBF_{ADC} (2)

The total RF noise referenced at the ADC input is given by equation (3).

N_{T}=kTBG_{T}F_{T} (2)

The cascaded noise figure is given by equation (4).

$${F}_{T\_Rx} = {F}_{T} + \frac{{F}_{ADC} - 1}{{G}_{T}} \qquad ( 4 )$$

Equation (4) shows that the cascaded noise figure is improved when G_{T} is increased due to the larger nominal (G0) gain state compare to the G1 gain state and due to the decreased total RF noise figure F_{T} when in the nominal (G0) gain state.

Equation (5) defines the noise ratio (NR).

$$\begin{matrix}NR = \frac{{kTBG}_{T} {F}_{T} + {kTBF}_{ADC}}{{kTBG}_{T} {F}_{T}} \\ = \frac{{N}_{RF} + {N}_{ADC}}{{N}_{RF}} \approx \frac{{G}_{T} {F}_{T} + {F}_{ADC}}{{G}_{T} {F}_{T}} \\ = 1 + \frac{{F}_{ADC}}{{G}_{T} {F}_{T}}\end{matrix} \qquad ( 5 )$$

where N_{ADC} in equation (5) is the ADC noise density given by equation (2), k is the Boltzmann constant, T is room temperature in Kelvin, G_{T} is the total RF gain, F_{T} is the total RF noise figure and F_{ADC} is the ADC noise figure.

Equation (5) shows that a low noise figure LNA with high gain results in the RF noise N_{RF} higher than the ADC noise N_{ADC}. This relationship shows that the ADC noise contribution to the overall system noise figure is negligible.

Equation (6) defines the takeover gain (TOG).

$$\begin{matrix}TOG = \frac{{kTBG}_{T} {F}_{T} + {kTBF}_{ADC}}{{kTBF}_{ADC}} \\ = \frac{{N}_{RF} + {N}_{ADC}}{{N}_{ADC}} \\ = 1 + \frac{{N}_{RF}}{{N}_{ADC}} \\ = 1 + \frac{{G}_{T} {F}_{T}}{{F}_{ADC}}\end{matrix} \qquad ( 6 )$$

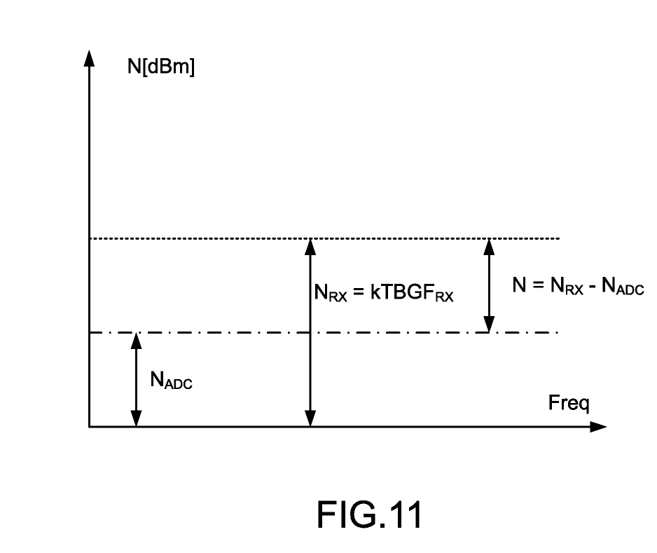

As shown by equation (6), a higher take over gain (TOG) implies that the ADC noise contribution is lower. And, the NR improves and the cascaded noise figure F_{T}_{_{—}}_{Rx} approaches F_{T}. FIG. 11 is a spectral plot of noise (measured in dBm) versus frequency. FIG. 11 illustrates an example ratio between the RF noise (N_{Rx}) to the ADC noise (N_{ADC}) at the analog output of the mixer/low pass filter (LPF) 930 (shown in FIG. 9) versus frequency. ΔN=N_{Rx}−N_{ADC} represents the ratio between the RF noise (N_{Rx}) and the ADC noise (N_{ADC}) in logarithmic units (in dB).

The dual mode AGC receiver utilizes the nominal (G0) gain state with improved noise figure and higher gain to improve the cascaded noise figure F_{T}_{_{—}}_{Rx} compared to the cascaded noise figure under the G1 gain state. The performance improvement is possible because under the G0 gain state, G_{T} is higher compared to the G1 gain state. Therefore, the cascaded noise figure F_{T}_{_{—}}_{Rx} is further improved and approaches F_{T} as shown in equation (4) and the takeover gain is improved.

Equation (7) shows the cascaded noise figure (NF) ratio between the G1 gain state and the G0 gain state. Equation (8) shows the TOG ratio between the G1 gain state and the G0 gain state.

$$\begin{matrix}Δ NF = 10 log ( \frac{{F}_{T @ G 1} + \frac{{F}_{ADC} - 1}{{G}_{T @ G 1}}}{{F}_{T @ G 0} + \frac{{F}_{ADC} - 1}{{G}_{T @ G 0}}} ) & ( 7 ) \\ Δ TOG = 10 log ( \frac{{G}_{T @ G 1} {F}_{T @ G 1} ( 1 + \frac{{F}_{ADC}}{{G}_{T @ G 1} {F}_{T @ G 1}} )}{{G}_{T @ G 0} {F}_{T @ G 0} ( 1 + \frac{{F}_{ADC}}{{G}_{T @ G 0} {F}_{T @ G 0}} )} ) & ( 8 )\end{matrix}$$

The AGC circuit interaction with the jammer detector (JD) is illustrated in FIG. 10A where gain states and noise figure states for operation modes are provided in FIGS. 4-6. The inputs for a processor algorithm are LNA-Mixer gain state, DVGA (digital variable gain amplifier) state, jammer detector interrupt status and EE (energy estimator) value. Based upon these inputs and energy estimation, a new AGC state, a new LNA state and a new DVGA state are calculated. In one aspect, a processor 905 (not shown) in the dual mode AGC receiver performs the calculations. In one example the processor 905 is part of the AGC circuit 1020.

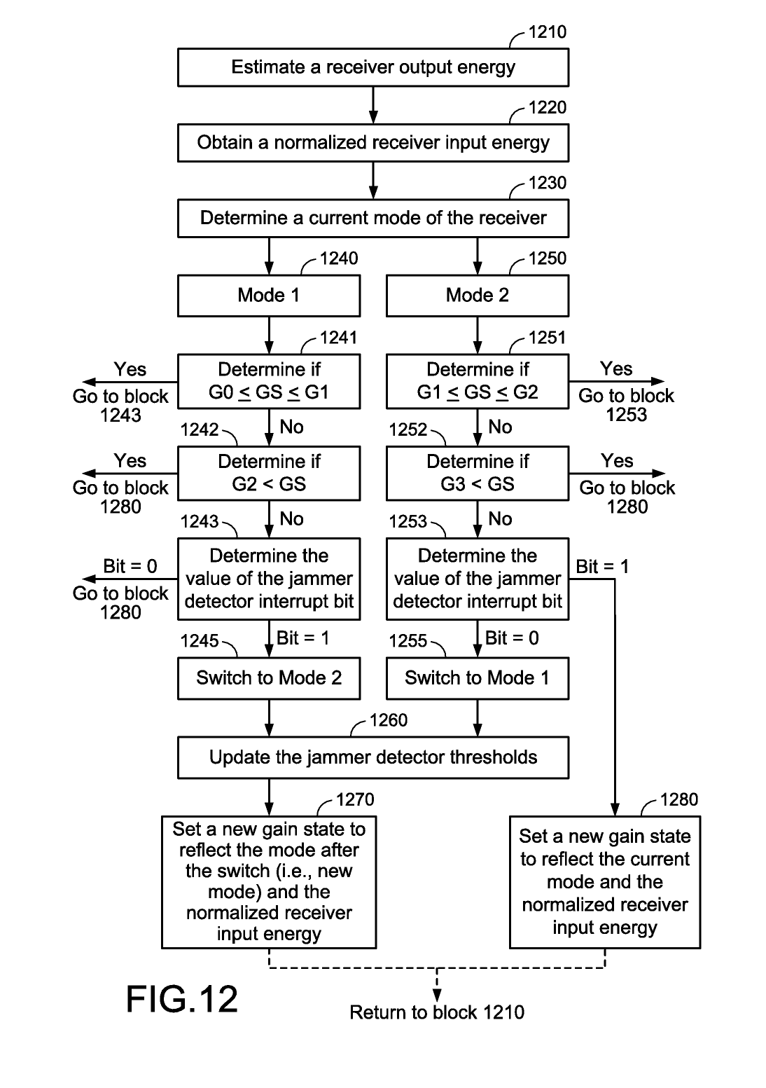

FIG. 12 illustrates an example flow diagram for toggling between dual modes (such as a high sensitivity mode and a high linearity mode) based on the input signal environment (i.e., input signal level). In block 1210, estimate a receiver input energy of the dual mode AGC receiver. In one aspect, the receiver input energy is measured at baseband, for example, at the input to the ADC, at the output of the ADC or at the output of the DVGA. The receiver input energy includes the jammer energy, desired signal level and noise level. In block 1220, obtain a normalized receiver input energy at the receiver front end (i.e., at the dual mode AGC receiver input to one of the LNAs shown in FIG. 9) by dividing the receiver input energy at baseband by an aggregate gain. In one aspect, the processor 905 obtains the normalized receiver input energy. The aggregate gain includes one or more of the gain of the DVGA 950, the ADC 940, the mixer/LPF 930 and one of the two LNAs (shown in FIG. 9) depending on the mode of the dual mode AGC receiver. In block 1230, determine the current mode of the dual mode AGC receiver. If the dual mode AGC receiver is in mode 1 (high sensitivity mode), proceed to block 1240. In block 1240, for example, use mode 1 AGC SP Table (with switch points S11 through S16). If the dual mode AGC receiver is in mode 2 (high linearity mode), proceed to block 1250. In block 1250, for example, use mode 2 AGC SP Table (with switch points S21 through S26). Following block 1240, in block 1241, determine if the gain state (GS) is greater than or equal to G0 and less than or equal to G1 (i.e., G0≦GS≦G1). In one example, determine if the mode 1 comparator threshold is for G0 or G1. If the gain state (GS) is greater than or equal to G0 and less than or equal to G1, proceed to block 1243. If the gain state (GS) is not greater than or equal to G0 and less than or equal to G1, proceed to block 1242. In block 1242, determine if the gain state (GS) is greater than G2. In one example, determine if the mode 1 comparator threshold is for G2. If the gain state (GS) is greater than G2, proceed to block 1280. If the gain state (GS) is not greater than G2, proceed to block 1243. In block 1243, determine the value of the jammer detector interrupt bit. The value of the jammer detector interrupt bit is based on the input signal level and a jammer detector threshold THⱼ. The value of the jammer detector interrupt bit is used to decide whether or not to switch the current mode to a new mode. If the jammer detector interrupt bit is 1, proceed to block 1245 to switch the dual mode AGC receiver to mode 2 (high linearity mode) and use mode 2 AGC SP Table (with switch points S21 through S26). If the jammer detector interrupt bit is 0, proceed to block 1280. In one example, the state of the jammer detector is based on the input to the jammer detector and the status of the jammer detector interrupt bit.

Following block 1250, in block 1251, determine if the gain state (GS) is greater than or equal to G1 and less than or equal to G2 (i.e., G1≦GS≦G2). In one example, determine if the mode 2 comparator threshold is for G1 or G2. If the gain state (GS) is greater than or equal to G1 and less than or equal to G2, proceed to block 1253. If the gain state (GS) is not greater than or equal to G1 and less than or equal to G2, proceed to block 1252. In block 1252, determine if the gain state (GS) is greater than G3. In one example, determine if the mode 2 comparator threshold is for G3. If the gain state (GS) is greater than G3, proceed to block 1280. If the gain state (GS) is not greater than G3, proceed to block 1253. In block 1253, determine the value of the jammer detector interrupt status bit. The value of the jammer detector interrupt status bit is based on the input signal level and the jammer detector threshold THⱼ. The value of the jammer detector interrupt status bit is used to decide whether or not to switch the current mode to a new mode. If the jammer detector interrupt status bit is 0, proceed to block 1255 to switch the dual mode AGC receiver to mode 1 (high sensitivity mode) and use mode 1 AGC SP Table (with switch points S11 through S16). If the jammer detector interrupt status bit is 1, proceed to block 1280.

Following block 1245 or block 1255, proceed to block 1260. In block 1260, update the jammer detector thresholds. In one aspect, the jammer detector thresholds in the jammer counters (not shown) are updated. In another aspect, the jammer detector thresholds in the jammer comparators (not shown) are updated. Following block 1260, proceed to block 1270. In block 1270, set a new gain state to reflect the mode of the dual mode AGC receiver after the switch (i.e., a new mode) and to reflect the normalized receiver input energy. In block 1270, the jammer detector thresholds are updated in the jammer comparators based on the new gain states. In block 1280, set a new gain state to reflect the current mode of the dual mode AGC receiver and to reflect the normalized receiver input energy. In block 1280, the jammer detector thresholds are updated in the jammer comparators based on the new gain state. In one aspect, the new gain state may be equal to the gain state (GS). In one example, the new gain state in blocks 1270 or 1280 includes the LNA gain and/or post-LNA gain. In one aspect, following either blocks 1270 or 1280, return to block 1210. One skilled in the art would understand that the algorithm or portions thereof illustrated in FIG. 12 can be repeated without affecting the spirit or scope of the present disclosure. In one aspect, portions of the algorithm illustrated in FIG. 12 are performed by a processor 905 (not shown) within the dual mode AGC receiver 900. In another aspect, the processor 905 is part of the AGC circuit 1020.

Those of skill would appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processor(s) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor. Additionally, the various illustrative flow diagrams, logical blocks, modules and/or algorithm steps described herein may also be coded as computer-readable instructions carried on any computer-readable medium known in the art.

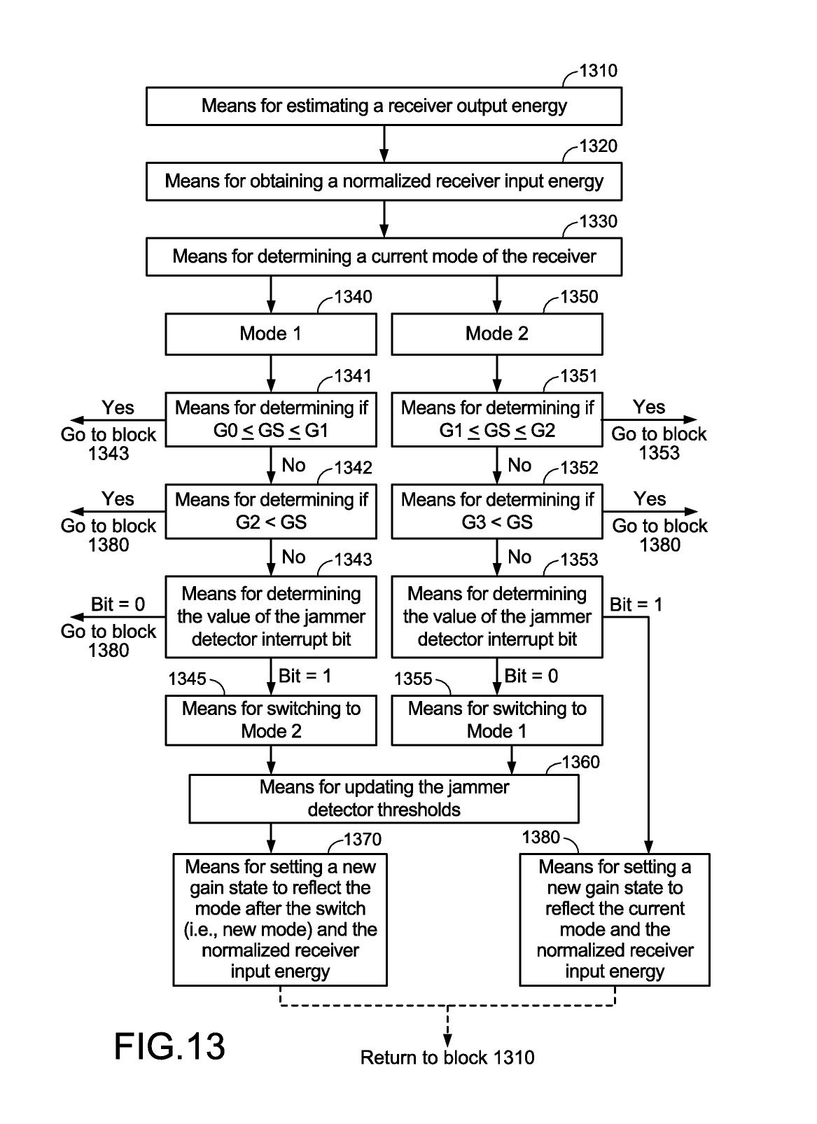

FIG. 13 illustrates an example of a device 1300 suitable for toggling between dual modes (such as a high sensitivity mode and a high linearity mode) based on the input signal environment. In one aspect, the device 1300 is implemented by at least one processor comprising one or more modules configured to provide different aspects for toggling between dual modes (such as a high sensitivity mode and a high linearity mode) based on the input signal environment as described herein in blocks 1310, 1320, 1330, 1340, 1341, 1342, 1343, 1345, 1350, 1351, 1352, 1353, 1355, 1360, 1370 and 1380. For example, each module comprises hardware, firmware, software, or any combination thereof. In one aspect, the device 1300 is also implemented by at least one memory in communication with at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A receiver with a first mode and a second mode, wherein the receiver is toggled between the first mode and the second mode based on an input RF signal level, the receiver comprising:
a first LNA operating in the first mode;
a second LNA operating in the second mode;
a jammer detector to provide a jammer interrupt bit to indicate the presence of a jammer; and
an automatic gain control (AGC) circuit coupled to the jammer detector for receiving the jammer interrupt bit, wherein the AGC circuit selects between the first LNA and the second LNA based on the jammer interrupt bit and a gain state comparison.

2. The receiver of claim 1 further comprising:
a mixer coupled to one of the first and second LNAs for downconverting the input RF signal to a downconverted signal; and
a low pass filter (LPF) coupled to the mixer for filtering the downconverted signal to generate a filtered downconverted signal.

3. The receiver of claim 2 further comprising an analog to digital converter (ADC) coupled to the LPF for digitizing the filtered downconverted signal to produce a digitized signal and inputting the digitized signal into a digital variable gain amplifier (DVGA), wherein the DVGA scales the digitized signal.

4. The receiver of claim 3 further comprising an energy estimator coupled to the DVGA to estimate a receiver output energy based on the scaled digitized signal, wherein the receiver output energy is inputted to the jammer detector for use in setting a jammer detector threshold.

5. The receiver of claim 4 wherein the value of the jammer interrupt bit is based on a comparison of the level of the RF input signal against the jammer detector threshold.

6. The receiver of claim 1 further comprising a processor to obtain a normalized receiver input energy at the input to one of the first and second LNAs based on the receiver input energy at baseband.

7. The receiver of claim 6 wherein the processor sets a new gain of the receiver to reflect the new mode and the normalized receiver input energy.

8. The receiver of claim 7 wherein the processor directs the jammer detector to update the jammer detector threshold.

9. A receiver with a first mode and a second mode, wherein the receiver is toggled between the first mode and the second mode based on an input signal level, the receiver comprising:
a first LNA operating in the first mode;
a second LNA operating in the second mode;
a jammer detector to provide a jammer interrupt bit to indicate the presence of a jammer; and
means for receiving the jammer interrupt bit and selecting between the first LNA and the second LNA based on the jammer interrupt bit and a gain state comparison.

10. The receiver of claim 9 further comprising means for setting a new gain of the receiver to reflect the selection between the first LNA and the second LNA.

11. A method for toggling between a first mode and a second mode of a receiver based on an input signal level, the method comprising:
comparing a gain state of the receiver to at least one gain state thresholds;
determining the presence of a jammer; and
switching a current mode of the receiver to a new mode based on the presence of the jammer and the comparison of the gain state.

12. The method of claim 11 further comprising determining the current mode of the receiver wherein the current mode is either a high linearity mode or a high sensitivity mode.

13. The method of claim 12 further comprising estimating a receiver output energy.

14. The method of claim 13 further comprising obtaining a normalized receiver input energy based on the receiver output energy.

15. The method of claim 14 further comprising setting a new gain of the receiver to reflect the new mode and the normalized receiver input energy.

16. The method of claim 15 further comprising updating the jammer detector threshold.

17. The method of claim 11 further comprising estimating a receiver output energy.

18. The method of claim 17 further comprising obtaining a normalized receiver input energy based on the receiver output energy.

19. The method of claim 18 further comprising making a decision not to switch from the current mode to the new mode.

20. The method of claim 19 further comprising setting a new gain of the receiver to reflect the current mode and the normalized receiver input energy.

21. A computer-readable medium storing a computer program, wherein execution of the computer program is for:
comparing a gain state of the receiver to one or more gain state thresholds;
determining the value of a jammer detector interrupt bit wherein the jammer detector interrupt bit is based on the input signal level and a jammer detector threshold; and
deciding to switch or not to switch a current mode to a new mode based on the value of the jammer detector interrupt bit and the comparison of the gain state.

22. The computer-readable medium of claim 21 wherein execution of the computer program is also for determining the current mode of the receiver wherein the current mode is either a high linearity mode or a high sensitivity mode.
